(19) United States
(12) Patent Application Publication
(10) Pub. No.: US 2026/0322876 A1
(43) Pub. Date: Oct. 15, 2026

(54) PACKET ACCELERATOR IN ETHERNET SWITCH

(71) Applicant: Infineon Technologies America Corp., El Segundo, CA (US)

(72) Inventor: Arijit De, Bengaluru (IN)

(73) Assignee: Infineon Technologies America Corp., El Segundo, CA (US)

(21) Appl. No.: 19/643,336

(22) Filed: Apr. 9, 2026

Related U.S. Application Data
(60) Provisional application No. 63/786,869, filed on Apr. 10, 2025.

(51) Int. Cl. H04L 67/1097

(52) U.S. Cl. CPC H04L 67/1097

(57) ABSTRACT

A method of processing network frames is disclosed. The method can include receiving the network frames, where each network frame comprises a header and a payload that comprises sensor data associated with a sensor frame; for each network frame, determining whether the header of the network frame is a beginning header of headers of the network frames, in response to determining that the header of the network frame is the beginning header, performing a first direct memory access (DMA) operation to write the beginning header to a memory of a system on a chip (SoC), and performing a second DMA operation to write the payload of the network frame to the memory of the SoC; and issuing an interrupt to a processor of the SoC.

### CROSS-REFERENCE TO RELATED APPLICATION

This application claims the benefit of U.S. Provisional Application No. 63/786,869 filed on Apr. 10, 2025, the disclosure of which is incorporated herein by reference.

### TECHNICAL FIELD

Embodiments of the disclosure relate generally to Ethernet networks. More particularly, embodiments of the disclosure relate to a packet accelerator in Ethernet switches.

### BACKGROUND

In modern advanced driver-assistance systems (ADAS) vehicles, multiple cameras are mounted around and/or inside a vehicle, with each camera transmitting uncompressed video at a very high speed (e.g., gigabit rates) to the ADAS system on a chip (SoC) for processing. Typically, an in-vehicle infotainment (IVI) display shows overlays of multiple camera images and metadata for notifications. Transmitting uncompressed video frames from the ADAS SoC to the IVI SoC over Ethernet requires significant processing powers in both SoCs.

Many vehicle sensors, including cameras, light detection and ranging (Lidar), and radio detection and ranging (Radar), generate several gigabits per second (Gbps) of data. Generally, this sensor data is packetized into Ethernet frames using the Institute of Electrical and Electronics Engineers (IEEE) 1722b generic image sensor format (GISF) and transmitted to the SoC over the Ethernet network. The IEEE 1722, or Audio Video Transport Protocol (AVTP), is an IEEE standard that defines how to transport time-sensitive audio, video, and control data over Ethernet-based networks. Processing these large sensor frames frame-by-frame on an embedded SoC can lead to significant processing overhead, central processing unit (CPU) throttling and non-real-time behavior, which is critical for safety applications, such as displaying notification videos on the IVI display for a driver of the vehicle to take appropriate safety actions. Therefore, such processing delays can potentially lead to life-threatening situations.

For example, one RGB888 720p frame size has Total Pixels * 24 bits = 1280 * 720 * 24 bits. For a 1500-byte maximum transmission unit (MTU), it takes 1843 Ethernet frames to construct a single video frame. For an embedded SoC where multiple cameras are connected, processing 1843 * 30 fps = 55290 frames per second from each camera is not a feasible solution. This challenge can also persist in any scenario where high-bandwidth data needs to be transmitted from one SoC to another network element within the in-vehicle Ethernet network.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a network system according to an embodiment.

FIG. 2 is a block diagram illustrating another network system according to an embodiment.

FIG. 3 is a block diagram illustrating an accelerator engine that processes Ethernet frames according to an embodiment.

FIG. 4 is a block diagram illustrating an accelerator engine that packetizes and transmits Ethernet frames according to an embodiment.

FIG. 5 is a flow diagram of a process of processing Ethernet frames according to an embodiment.

FIG. 6 is a flow diagram of a process of packetizing and transmitting Ethernet frames according to an embodiment.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

According to one aspect, an Ethernet switch or aggregator described herein may add support for an accelerator engine, e.g., IEEE 1722b GISF accelerator engine. Instead of writing Ethernet frames (e.g., IEEE 1722b frames) frame-by-frame, the accelerator engine may write a header (e.g., IEEE 1722b header) and required metadata to a memory of a SoC, e.g., random access memory (RAM), over a peripheral component interconnect express (PCIe) bus for sensor data processing. The GISF data payload (gisf_data_payload) may be written or transferred to the SoC memory via a direct memory access (DMA) engine. In an embodiment, scatter-gather mechanism may be used to hold a full sensor frame. Scatter-gather mechanism refers to a high-performance DMA technique that allows a network interface card (NIC) to read or write data (e.g., sensor data) across multiple, non-contiguous memory buffers in the host memory (e.g., SoC RAM) as a single, contiguous stream. It eliminates the need to copy data into one large contiguous memory block, thereby significantly reducing CPU overhead. Once a full sensor frame is available to the memory, the Ethernet aggregator PCIe endpoint may issue an interrupt, e.g., message signaled interrupt (MSI)/message signaled interrupt eXtended (MSIx) interrupt, to the SoC CPU.

According to another aspect, an Ethernet switch or aggregator described herein may include an accelerator engine, e.g., 1722b accelerator, to packetize high bandwidth data (e.g., sensor frames) into a protocol format (e.g., 1722b GISF format) used to stream uncompressed (raw) video data from cameras over Ethernet-based networks. Scatter-gather mechanism may be used to hold sensor frame data in a SoC memory and the accelerator engine may DMA out the data from the SoC memory, packetize the data into Ethernet frames (e.g., 1722b GISF frames) and transmit the frames over an Ethernet network.

According to one aspect, methods and apparatuses for processing network frames are provided. For example, the method may include receiving a plurality of network frames, each network frame of the plurality of network frames comprising a header and a payload that comprises sensor data associated with a sensor frame. The method may further include for each network frame, determining whether the header of the network frame is a beginning header of a plurality of headers of the plurality of network frames, in response to determining that the header of the network frame is the beginning header, performing a first direct memory access (DMA) operation to write the beginning header to a memory of a system on a chip (SoC), and performing a second DMA operation to write the payload of the network frame to the memory of the SoC. The method may further include issuing an interrupt to a processor of the SoC.

According to another aspect, methods of creating and transmitting network frames are provided. For example, the method may include performing at least one DMA operation to read a sensor frame and metadata associated with the sensor frame from a memory of a SoC. The method may further include packetizing the sensor frame into a plurality of payloads. The method may further include for each payload of the plurality of payloads, creating a header based on the metadata associated with the sensor frame, encapsulating the payload with the header, encapsulating the header and the payload with a network header to form a network frame, and transmitting the network frame.

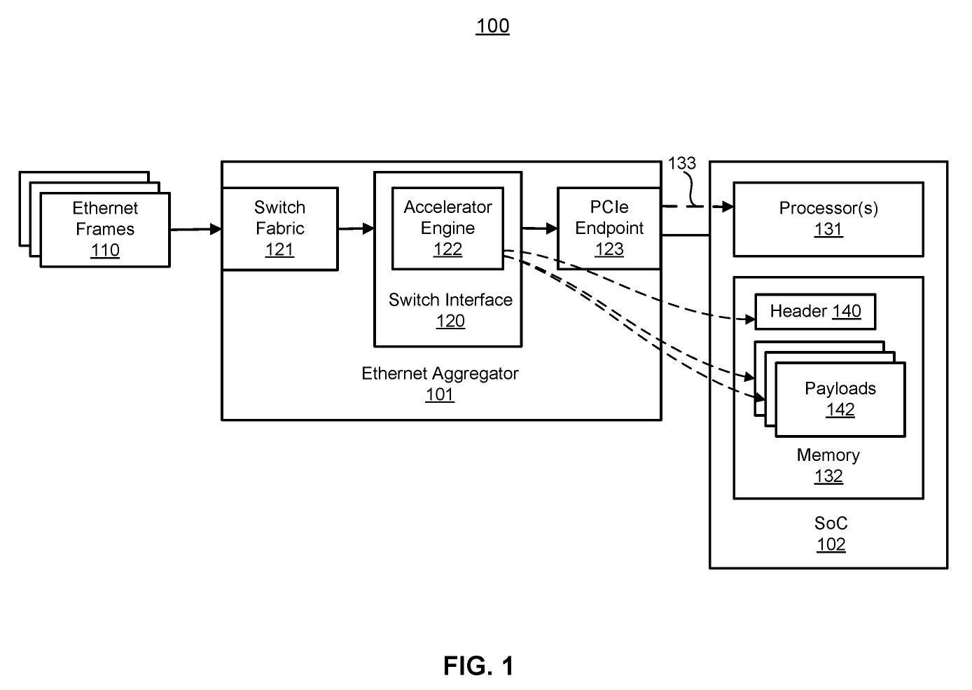

FIG. 1 is a block diagram illustrating a network system according to an embodiment. Referring to FIG. 1, network system 100 includes, but is not limited to, an Ethernet aggregator or switch 101 and a SoC 102. The SoC 102 may be any embedded SoC, such as an ADAS SoC, IVI SoC, etc. Referring to FIG. 1, SoC 102 may include processor(s) 131 and memory 132, with the memory 132 communicating with processor(s) 131. Processor(s) 131 may represent a single processor or multiple processors with a single processor core or multiple processor cores included therein. Processor(s) 131 may represent one or more general-purpose processors such as a microprocessor, a central processing unit (CPU), neural processing unit (NPU), graphics processing unit (GPU) or the like. More particularly, processor(s) 131 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor(s) 131 may also be one or more special-purpose processors such as an application specific integrated circuit (ASIC), a cellular or baseband processor, a field programmable gate array (FPGA), a digital signal processor (DSP), a network processor, a graphics processor, a communications processor, a cryptographic processor, a co-processor, an embedded processor, or any other type of logic capable of processing instructions. In an embodiment, memory 132 may include one or more volatile storage (or memory) devices such as random access memory (RAM), dynamic RAM (DRAM), synchronous DRAM (SDRAM), static RAM (SRAM), or other types of storage devices.

As shown, Ethernet aggregator 101 may include a switch fabric 121, a switch interface 120, and a PCIe endpoint 123. In an embodiment, switch fabric 121 may receive Ethernet (network) frames or packets 110 from another SoC, for example, and transfer the Ethernet frames 110 from an input port to an output port. Each of the frames 110 may include a GISF frame that includes an IEEE 1722b or GISF header and a payload that includes or carries sensor data, which may a portion or an entirety of a full sensor frame (e.g., video frame or image from cameras, Lidar, Radar, etc.). In an embodiment, the GISF header may include metadata that describes, controls and synchronizes the sensor data being transported in the payload. The metadata may be generated alongside the sensor frames (e.g., video frames or images from cameras, Lidar, Radar, etc.). In an embodiment, the Ethernet frame 110 may also include an Ethernet (network) header that encapsulates the GISF frame. The Ethernet header, for example, may be an automotive control format (ACF) audio/video transport protocol data unit (AVTPDU) header used for transporting low-latency control data, such as automotive network frames (e.g., controller area network (CAN), local interconnect network (LIN), etc.) over Ethernet-based audio video bridging (AVB) or time-sensitive networking (TSN) network.

In some embodiments, switch fabric 121 may include circuitry, e.g., a crossbar switch, that connects all ports (input and output) to enable simultaneous, efficient network traffic flow. In an embodiment, switch fabric 121 may define the total bandwidth the Ethernet aggregator 101 can handle, which determines the performance level of the aggregator 101. Switch fabric 121 may be a crossbar switch fabric, shared memory switch fabric, shared bus switch fabric, etc.

In FIG. 1, switch fabric 121 receives the Ethernet frames 110 through an input port and transmits the frames 110 to an output port to switch interface 120. Switch interface 120 may be a physical or logical connection point used to send and receive Ethernet frames 110, allowing devices, such as SoCs, to communicate with one another. In an embodiment, interface 120 may be configured as an access port (for end devices, such as SoC 102) or a trunk port (between switches/routers) to manage network traffic, virtual local area network (VLAN) membership, speed, and duplex settings. Interface 120 may be a physical interface (e.g., RJ-45, fiberoptic, or Ethernet ports), a switch virtual interface (e.g., logical, software-based interface associated with a VLAN), a routed port (e.g., a physical port on a Layer 3 switch configured to act as a router port), or a management interface (e.g., a dedicated port for managing the switch itself rather than passing user traffic).

With continued reference to FIG. 1, switch interface 120 may include an accelerator engine 122. Accelerator engine 122 may be implemented using hardware (e.g. circuitry, dedicated logic, etc.), software (e.g., embodied on a non-transitory computer readable medium), or a combination of both. Accelerator engine 122 may support the IEEE 1722b protocol, such as the GISF format used to transport raw (uncompressed) sensor data or frames (e.g., video frames or images) over Ethernet-based networks. In an embodiment, when receiving Ethernet frames 110 from switch fabric 121, instead of writing or transmitting the frames 110 frame-by-frame to SoC 102, accelerator engine 122 may write or transfer a header 140 (e.g., the first GISF header from a sequence of GISF headers in frames 110) to memory 132. The header 140 may be written to memory 132 over a PCIe bus (not shown) coupled to PCIe endpoint 123 or using an integrated DMA engine in aggregator/switch 101 (e.g., in PCIe endpoint 123). The accelerator engine 122 may also write or transfer the payloads from frames 110 to memory 132. For example, engine 122 may use the integrated DMA engine in aggregator/switch 101 (e.g., in PCIe endpoint 123) to write the payloads (sensor data) to memory 132. Once all payloads for a full sensor frame (e.g., video frame or image) have been written or transferred to memory 132 (i.e., available to memory 132), accelerator engine 122 may signal PCIe endpoint 123 to issue an interrupt 133 (e.g., MSI/MSIx interrupt) to processor(s) 131. Accordingly, processor(s) 131 may process the payloads (sensor data) to reconstruct the sensor frame. In an embodiment, a scatter-gather mechanism may be used to hold the full sensor frame in memory 132 to reduce processor overhead and memory latency.

In an embodiment, PCIe endpoint 123 may be a peripheral device at the end of a PCI express link, such as a GPU or NIC, that communicates with SoC 102. It may act as a slave device in point-to-point connections, sending and receiving data packets (e.g., Ethernet frames 110) using memory mapping, e.g., base address registers (BARs), to exchange data, such as accelerating tasks on SoC 102. In an embodiment, PCIe endpoint 123 may enable data transfer between the endpoint 123 and SoC 102 through DMA, e.g., using shared memory regions. As previously described, PCIe endpoint 123 may also send or issue interrupts (e.g., MSI/MSIx interrupts) to SoC 102 to signal events.

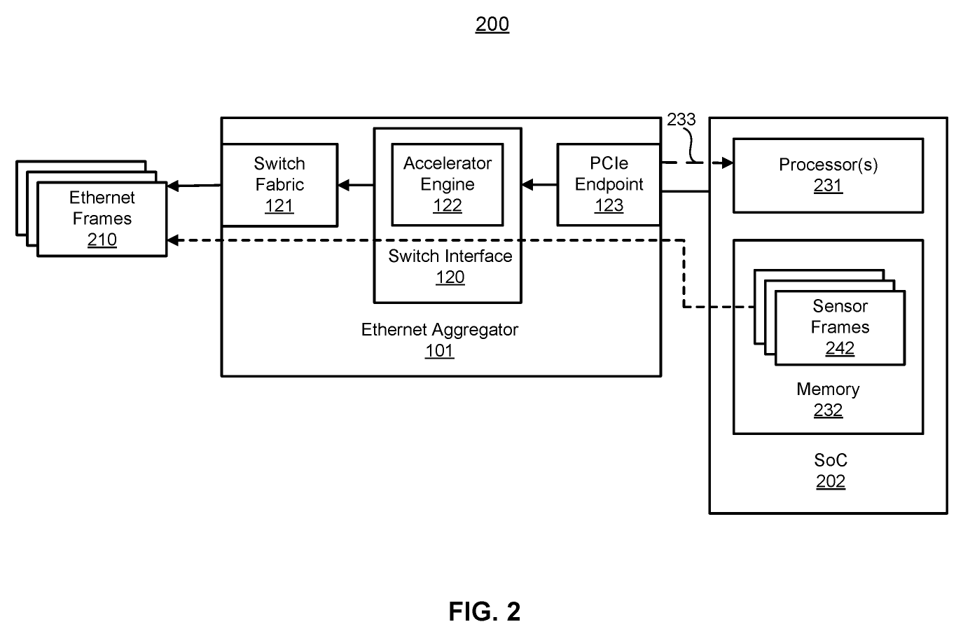

FIG. 2 is a block diagram illustrating another network system according to an embodiment. Referring to FIG. 2, network system 200 includes, but is not limited to, the Ethernet aggregator or switch 101 and a SoC 202. Aspects of the Ethernet aggregator 101 have been previously described, and for brevity’s sake, will not be described again herein.

The SoC 202 may be any embedded SoC, such as an ADAS SoC, IVI SoC, etc. Referring to FIG. 2, SoC 202 may include processor(s) 231 and memory 232, with the memory 232 communicating with processor(s) 231. Processor(s) 231 may represent a single processor or multiple processors with a single processor core or multiple processor cores included therein. Processor(s) 231 may represent one or more general-purpose processors such as a microprocessor, a CPU, NPU, GPU or the like. More particularly, processor(s) 231 may be a CISC microprocessor, RISC microprocessor, VLIW microprocessor, or processor implementing other instruction sets, or processors implementing a combination of instruction sets. Processor(s) 231 may also be one or more special-purpose processors such as an ASIC, a cellular or baseband processor, an FPGA, a DSP, a network processor, a graphics processor, a communications processor, a cryptographic processor, a co-processor, an embedded processor, or any other type of logic capable of processing instructions. In an embodiment, memory 232 may include one or more volatile storage (or memory) devices such as RAM, DRAM, SDRAM, SRAM, or other types of storage devices.

As illustrated in FIG. 2, memory 232 may store sensor frames 242 (e.g., video frames or images captured by cameras, Lidar, Radar, etc.). In an embodiment, a scatter-gather mechanism may be used to hold the sensor frames 242 in memory 232 to reduce processor overhead and memory latency. In an embodiment, accelerator engine 122 may read each of the sensor frames 242 from memory 232, packetize the sensor frame into payloads, format the payloads into the GISF format, and transmit the GISF frame over an Ethernet network. For example, engine 122 may use the DMA engine of PCIe endpoint 123 to read (or DMA out) each sensor frame 242 from memory 232. The sensor frame may then be broken into payloads (chunks) and each payload may be encapsulated with a GISF header to form a GISF frame. In an embodiment, the GISF frame may be encapsulated with an Ethernet header (e.g., AVTPDU) to form an Ethernet frame 210 that can be transmitted to a SoC (e.g., SoC 102 of FIG. 1) over the Ethernet network through switch fabric 121.

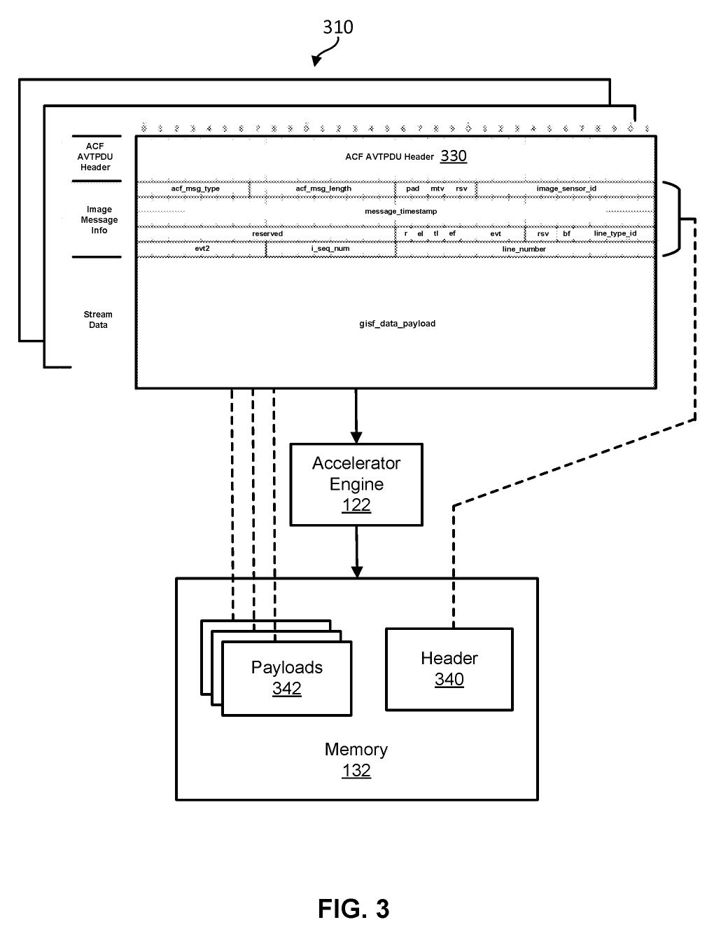

FIG. 3 is a block diagram illustrating an accelerator engine that processes Ethernet frames according to an embodiment. Referring to FIG. 3, accelerator engine 122 may receive Ethernet frames 310 from a SoC (e.g., SoC 202 of FIG. 2). As shown, each Ethernet frame 310 may include an ACF AVTPDU header 330, a GISF header 340, and GISF data payload 342. ACF AVTPDU header 330 may be used for transporting low-latency control data, such as automotive network frames (e.g., CAN, LIN, etc.) over Ethernet-based AVB or TSN network

In an embodiment, GISF header 340 may include metadata that describes the data payload 342. For example, the metadata may include a message length (acf_msg_length) indicating the size of the payload 342 (sensor data), a message timestamp (message_timestamp) related to when the sensor data in the payload 342 was captured, an image sensor identifier (image_sensor_id) that identifies a particular sensor (e.g., camera, Lidar, Radar, etc.) that produced the sensor data in the payload 342, a line type identifier (line_type_id) that identifies a specific type or profile of a line of data, an image sequence number (i_seq_num) that indicates the sequence of the sensor frames for tracking the order of the frames, a line number (line_number) that identifies the specific line of a sensor frame being transmitted within a GISF frame, and an end of chirp identifier (tl) that indicates the current AVTPDU is the last segment of a radar chirp.

As further shown in FIG. 3, the GISF header 340 may include other information associated with the GISF frame. For example, header 340 may include a message type (acf_msg_type) indicating an ACF type (e.g., CAN, LIN, etc.), a begin frame (bf) flag that indicates whether a current payload 342 (or GISF frame) is the beginning (first) payload (or GISF frame) of a sensor frame, an end frame (ef) flag that indicates whether the current payload 342 is the last payload of the sensor frame, a message timestamp valid (mtv) flag that indicates whether the message_timestamp field in the header 340 contains valid data, etc.

As previously described, when receiving Ethernet frames 310, instead of writing or transmitting the frames 310 frame-by-frame to memory 132, accelerator engine 122 may write or transfer GISF header 340 to memory 132. The header 140 may be written to memory 132 over a PCIe bus (not shown) or using an integrated DMA engine in a PCIe endpoint (e.g., PCIe endpoint 123). The accelerator engine 122 may also write or transfer the payloads 342 from frames 310 to memory 132. For example, engine 122 may use the integrated DMA engine in the PCIe endpoint 123 to write the payloads 342 to memory 132. Once all payloads of a full sensor frame (e.g., video frame or image) have been written or transferred to memory 132 (i.e., available to memory 132), accelerator engine 122 may signal the PCIe endpoint to issue an interrupt (e.g., MSI/MSIx interrupt) to processor(s) 131. Accordingly, processor(s) 131 may process the payloads (sensor data) to reassemble the sensor frame.

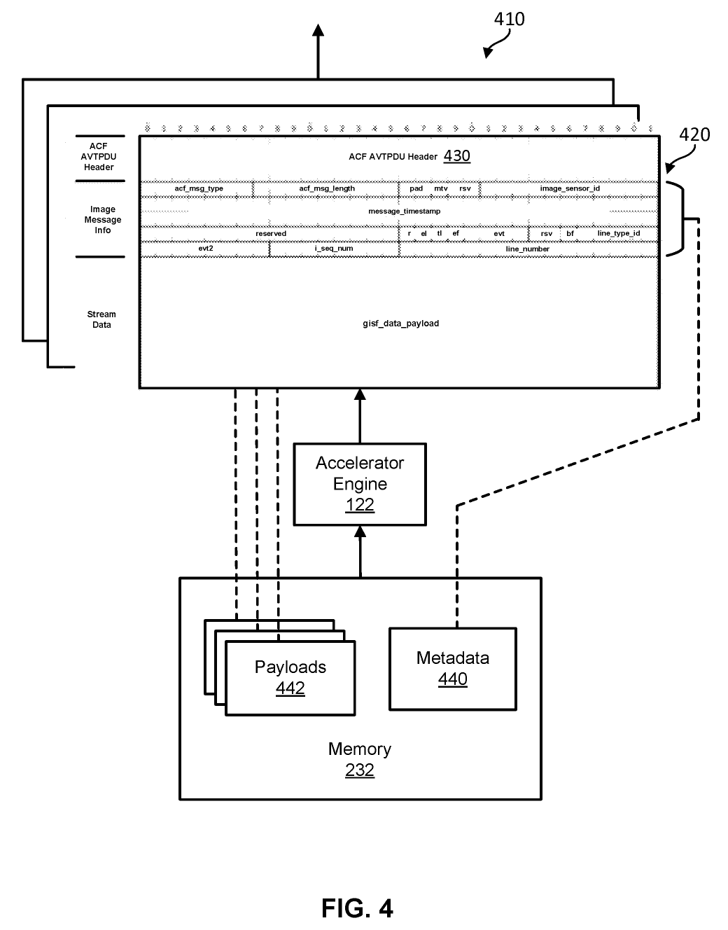

FIG. 4 is a block diagram illustrating an accelerator engine that packetizes and transmits Ethernet frames according to an embodiment. As illustrated in FIG. 4, memory 232 may store sensor frames (e.g., video frames) along with metadata 440 that describes each sensor frame. Metadata 440 may contain technical data (e.g., timestamp, resolution, codec, exposure, etc.), structural information (e.g., frame type, scene changes, etc.), and content data (e.g., global positioning system (GPS) location, objects detected, camera telemetry, etc.). In an embodiment, accelerator engine 122 may read each sensor frame and its metadata 440 from memory 232, packetize the sensor frame into the payloads 442, format each payload 442 into a GISF frame, and transmit the GISF frame as part of an Ethernet frame 410 over an Ethernet network. For example, engine 122 may use the DMA engine of the PCIe endpoint to read (or DMA out) each sensor frame from memory 232. The sensor frame may then be packetized into payloads 442 (chunks), where each payload 442 (gisf_data_payload) may be encapsulated with a GISF header 420 to create a GISF frame. In an embodiment, the GISF header 420 may be created or constructed for each payload 442 based on the respective metadata 440. For example, engine 122 may generate information associated with each payload 442 based on metadata 440, such as message length (acf_msg_length), message timestamp (message_timestamp), image sensor identifier (image_sensor_id), line type identifier (line_type_id), image sequence number (i_seq_num), line number (line_number), and end of chirp identifier (tl), as previously described. This information may be used to generate GISF header 420. In an embodiment, the GISF frame may be encapsulated with an Ethernet header 440 (e.g., ACF AVTPDU) to form an Ethernet frame 410 that can be transmitted to a SoC (e.g., SoC 102 of FIG. 1) over the Ethernet network. In an embodiment, the header 440 may be constructed based on metadata 440.

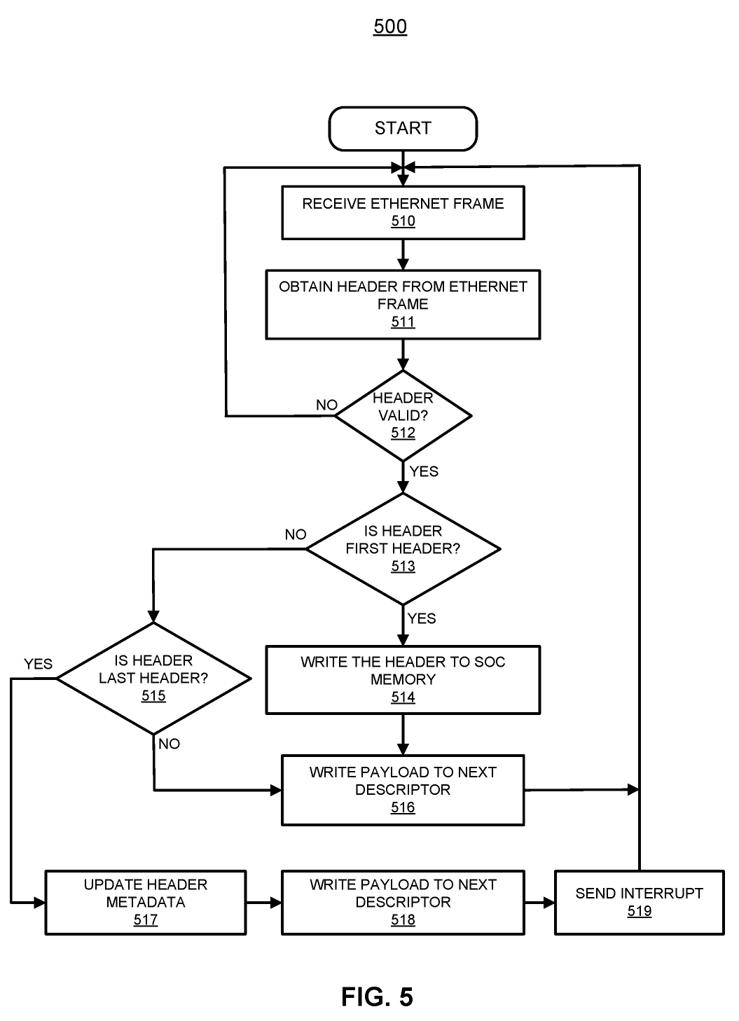

FIG. 5 is a flow diagram of a process of processing Ethernet frames according to an embodiment. Process 500 may be performed by processing logic which may include software, hardware, or a combination thereof. For example, process 500 may be performed by Ethernet aggregator 101 of FIG. 1 (e.g., accelerator engine 122).

Referring to FIG. 5, at block 510, the processing logic may receive an Ethernet frame, for example, from a SoC such as SoC 202 of FIG. 2. In an embodiment, the Ethernet (network) frame may include an ACF AVTPDU header and a GISF frame having a GISF header and GISF data payload.

At block 511, the processing logic may obtain a header (e.g., GISF header) from the Ethernet frame. For example, the processing logic may parse the Ethernet frame to extract the header from the Ethernet frame.

At block 512, the processing logic may determine whether the header is valid. In one embodiment, to determine the validity of the header, the processing logic may parse the header to obtain the image sequence number (i_seq_num) that indicates the sequence of the sensor frame associated with the GISF data payload, and determine whether the image sequence number is the correct sequence number. The image sequence number is correct, then the header is determined to be valid. Otherwise, the header is determined to be invalid. In another embodiment, the processing logic may also obtain the message timestamp valid (mtv) flag that indicates whether the message_timestamp field in the header contains valid data. If the mtv flag is TRUE (“1”), for example, then it is determined that the header is valid. Otherwise, if the mtv flag is FALSE (“0”), then it is determined that the header is invalid. Accordingly, if the header is valid, process 500 proceeds to block 513. Otherwise, process 500 returns to block 510. In an embodiment, prior to returning to block 510, the processing logic may perform error handling. For example, the processing logic may output an error code representing an invalid header.

At block 513, the processing logic may determine whether the header is the first header. For example, the processing logic may parse the header to obtain a begin frame (bf) flag that indicates whether the current GISF data payload is the beginning (first) payload for a sensor frame. If the bf flag is TRUE (“1”), for example, then it is determined that the header is the first header. If the bf flag is FALSE (“0”), then it is determined that the header is not the first header. Accordingly, if the header is the first header, process 500 proceeds to block 514. Otherwise, process 500 proceeds to block 515.

At block 514, the processing logic may write the header to a SoC memory (e.g., memory 132 of FIG. 1). In one embodiment, the processing logic may use a DMA engine in a PCIe endpoint to perform a DMA operation to write or transfer the header to the memory. In another embodiment, the processing logic may write the header to the memory over a PCIe bus.

At block 515, the processing logic may determine whether the header is the last header. For example, the processing logic may parse the header to obtain an end frame (ef) flag that indicates whether the current GISF data payload is the last payload for the sensor frame. If the ef flag is TRUE (“1”), for example, then it is determined that the header is the last header. If the ef flag is FALSE (“0”), then it is determined that the header is not the last header. Accordingly, if the header is the last header, process 500 proceeds to block 517. Otherwise, process 500 proceeds to block 516.

At block 516, the processing logic may write the payload to a next descriptor of the memory. For example, the processing logic may use a DMA engine to perform a DMA operation to write the payload to a current (available) memory buffer and update a pointer in a descriptor (e.g., a data structure) to move to the next available buffer (also referred to as scatter-gather operation). In this way, the processing overhead can be significantly reduced and processor throttling can be prevented.

At block 517, the processing logic may update the metadata of the header. For example, instead of writing another (current) header to the memory, the processing logic may simply update the existing header (e.g., first header) already written to the memory. For example, the processing logic may update or replace various fields in the existing header, such as message length (acf_msg_length), message timestamp (message_timestamp), image sensor identifier (image_sensor_id), line type identifier (line_type_id), image sequence number (i_seq_num), line number (line_number), and/or end of chirp identifier (tl), as previously described, to reflect the values associated with the last GISF frame. Alternatively, the processing logic may overwrite the existing header with the last header in the memory.

At block 518, the processing logic may write the payload to a next descriptor of the memory. This aspect has been described in block 516, and for brevity’s sake, will not be described again herein.

At block 519, the processing logic may send an interrupt to a processor of a SoC (e.g., processor(s) 131 of FIG. 1). As described, the processing logic may signal a PCIe endpoint (e.g., PCIe endpoint 123) to issue an interrupt (e.g., MSI/MSIx interrupt) to the processor to notify the processor that all payloads associated with the sensor frame is available in the SoC memory. Accordingly, the processor may process the payloads to reassemble the sensor frame.

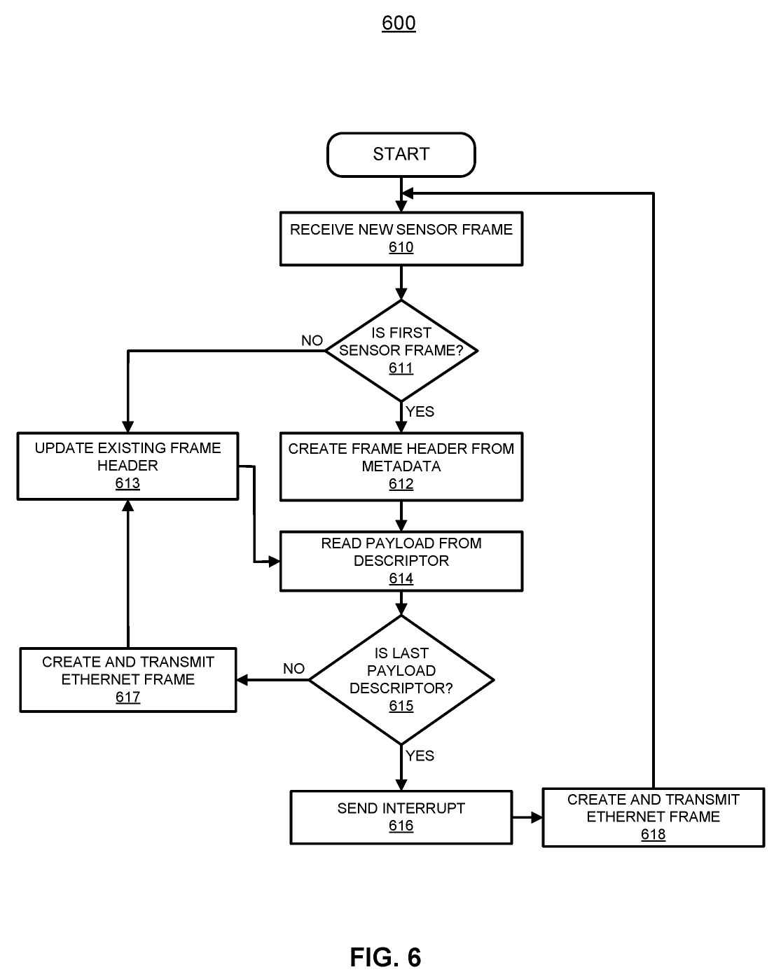

FIG. 6 is a flow diagram of a process of packetizing and transmitting Ethernet frames according to an embodiment. Process 600 may be performed by processing logic which may include software, hardware, or a combination thereof. For example, process 600 may be performed by Ethernet aggregator 101 of FIG. 2 (e.g., accelerator engine 122).

Referring to FIG. 6, at block 610, the processing logic may receive a new sensor frame, e.g., video frame or image captured by cameras, Lidar, Radar, etc. For example, the processing logic may use a DMA engine to perform a DMA operation to read (or DMA out) the sensor frame and/or its associated metadata from a memory of a SoC (e.g., memory 232 of FIG. 2).

At block 611, the processing logic may determine whether the sensor frame is a first (beginning) frame. For example, the processing logic may obtain the information in the metadata (e.g., frame counter, timestamp, etc.) corresponding to the sensor frame to determine whether the sensor frame is the first (beginning) sensor frame. If the sensor frame is the first sensor frame, process 600 proceeds to block 612. Otherwise, process 600 proceeds to block 613.

At block 612, the processing logic may create or construct a frame header (e.g., GISF header) based on the metadata. As previously described, processing logic may use the information in the metadata to populate a number of fields in the frame header, such as message length (acf_msg_length), message timestamp (message_timestamp), image sensor identifier (image_sensor_id), line type identifier (line_type_id), image sequence number (i_seq_num), line number (line_number), end of chirp identifier (tl), etc.

At block 613, the processing logic may update an existing frame header. For example, rather than constructing a new frame header, the processing logic may simply update or replace the values in the existing frame header (previously created in block 612) with the current values obtained from the current metadata.

At block 614, the processing logic may read a payload from a descriptor of a memory. For example, after reading the sensor frame via the DMA operation, the processing logic may packetize the sensor frame into a number of payloads stored in the memory of the SoC. Accordingly, the processing may read each payload from the descriptor of the memory.

At block 615, the processing logic may determine whether the payload is read from a last descriptor (i.e., last payload of the sensor frame). For example, the processing logic may check an end-of-chain flag or a pointer/address field within a descriptor structure to determine whether the descriptor is the last descriptor. If it is determined that the payload is read from the last descriptor of the memory, process 600 proceeds to block 616. Otherwise, process 600 proceeds to block 617.

At block 616, the processing logic may send an interrupt to a processor of the SoC (e.g., processor(s) 231 of FIG. 2). As described, the processing logic may signal a PCIe endpoint (e.g., PCIe endpoint 123) to issue an interrupt, such as interrupt 233 (e.g., MSI/MSIx interrupt), to the processor to notify the processor.

At block 617, the processing logic may create and transmit an Ethernet frame. For example, the processing logic may encapsulate the payload with the frame header (e.g., GISF header) created in block 612 to form a GISF frame. The processing logic may then encapsulate the GISF frame with an Ethernet header (e.g., ACF AVTPDU header) to form the Ethernet frame. Subsequently, the processing logic may transmit the Ethernet frame, for example, to another SoC such as SoC 102 of FIG. 1 over an Ethernet network.

At block 618, the processing logic may also create and transmit an Ethernet frame. This aspect has been described above in block 617, and for brevity’s sake, will not be described again herein. Subsequently, process 600 returns to block 610 to receive another sensor frame.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. The apparatus may include a processor and a memory coupled to the processor for storing instructions for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
receiving a plurality of network frames, each network frame of the plurality of network frames comprising a header and a payload that comprises sensor data associated with a sensor frame;
for each network frame,
determining whether the header of the network frame is a beginning header of a plurality of headers of the plurality of network frames,
in response to determining that the header of the network frame is the beginning header, performing a first direct memory access (DMA) operation to write the beginning header to a memory of a system on a chip (SoC), and
performing a second DMA operation to write the payload of the network frame to the memory of the SoC; and
issuing an interrupt to a processor of the SoC.

2. The method of claim 1, further comprising: prior to determining whether the header of the network frame is the beginning header, obtaining the header from the network frame.

3. The method of claim 1, further comprising: prior to issuing the interrupt to the processor of the SoC,
for each network frame, determining whether the header of the network frame is a last header of the plurality of headers.

4. The method of claim 3, wherein issuing the interrupt to the processor of the SoC comprises:
in response to determining that the header of the network frame is the last header, issuing the interrupt to the processor of the SoC.

5. The method of claim 4, further comprising: in response to determining that the header of the network frame is the last header, updating metadata of the beginning header with metadata of the last header.

6. The method of claim 1, further comprising: for each network frame, determining whether the header of the network frame is valid.

7. The method of claim 1, wherein the header of each network frame is a generic image sensor format (GISF) header, the payload of each network frame is a GISF data payload, and the plurality of network frames are Ethernet frames.

8. The method of claim 1, wherein each network frame further comprises a network header that encapsulates the header and the payload.

9. An apparatus comprising:
a processor; and
a memory coupled to the processor, the memory for storing instructions for the processor, the instructions for:
receiving a plurality of network frames, each network frame of the plurality of network frames comprising a header and a payload that comprises sensor data associated with a sensor frame;
for each network frame,
determining whether the header of the network frame is a beginning header of a plurality of headers of the plurality of network frames,
in response to determining that the header of the network frame is the beginning header, performing a first direct memory access (DMA) operation to write the beginning header to a memory of a system on a chip (SoC), and
performing a second DMA operation to write the payload of the network frame to the memory of the SoC; and
issuing an interrupt to a processor of the SoC.

10. The apparatus of claim 9, wherein the instructions are further for:
prior to determining whether the header of the network frame is the beginning header, obtaining the header from the network frame.

11. The apparatus of claim 9, wherein the instructions are further for:
prior to issuing the interrupt to the processor of the SoC, for each network frame, determining whether the header of the network frame is a last header of the plurality of headers.

12. The apparatus of claim 11, wherein issuing the interrupt to the processor of the SoC comprises:
in response to determining that the header of the network frame is the last header, issuing the interrupt to the processor of the SoC.

13. The apparatus of claim 12, wherein the instructions are further for:
in response to determining that the header of the network frame is the last header, updating metadata of the beginning header with metadata of the last header.

14. The apparatus of claim 9, wherein the instructions are for:
for each network frame, determining whether the header of the network frame is valid.

15. The apparatus of claim 9, wherein the header of each network frame is a generic image sensor format (GISF) header, the payload of each network frame is a GISF data payload, and the plurality of network frames are Ethernet frames.

16. The apparatus of claim 9, wherein each network frame further comprises a network header that encapsulates the header and the payload.

17. A computer-implemented method, comprising:
performing at least one direct memory access (DMA) operation to read a sensor frame and metadata associated with the sensor frame from a memory of a system on a chip (SoC);
packetizing the sensor frame into a plurality of payloads; and
for each payload of the plurality of payloads,
creating a header based on the metadata associated with the sensor frame,
encapsulating the payload with the header,
encapsulating the header and the payload with a network header to form a network frame, and
transmitting the network frame.

18. The method of claim 17, further comprising:
for each payload of the plurality of payloads,
determining whether the payload is a last payload, and
in response to determining that the payload is the last payload, issuing an interrupt to a processor of the SoC.

19. The method of claim 17, wherein the plurality of payloads are generic image sensor format (GISF) data payloads, the header is a GISF header, and the network header is an automotive control format (ACF) audio/video transport protocol data unit (AVTPDU) header.

20. The method of claim 17, further comprising: determining whether the sensor frame is a beginning sensor frame.
